(19) United States
(12) Patent Application Publication
(10) Pub. No.: US 2019/0228776 A1
(43) Pub. Date: Jul. 25, 2019

(54) SPEECH RECOGNITION DEVICE AND SPEECH RECOGNITION METHOD

(71) Applicant: Toyota Jidosha Kabushiki Kaisha, Toyota-shi Aichi-ken (JP)

(72) Inventor: Taiki Yamashita, Toyota-shi Aichi-ken (JP)

(73) Assignee: Toyota Jidosha Kabushiki Kaisha, Toyota-shi Aichi-ken (JP)

(21) Appl. No.: 16/249,495

(22) Filed: Jan. 16, 2019

(30) Foreign Application Priority Data
Jan. 19, 2018 (JP) 2018-007064

(51) Int. Cl. G10L 15/26; G10L 15/02; B60W 50/10

(52) U.S. Cl. CPC G10L 15/265; B60W 50/10; G10L 15/02

(57) ABSTRACT

A speech recognition device and a speech recognition method are disclosed. The speech recognition device includes: a communication unit configured to transmit data on a speech to a server device, and receive a first speech recognition result and a degree of reliability of the first speech recognition result from the server device; a speech recognition unit configured to acoustically recognize the speech and output a second speech recognition result and a degree of reliability of the second speech recognition result; and a selection unit configured to correct at least, one of the degree of reliability of the first speech recognition result and the degree of reliability of the second speech recognition result with a correction value corresponding to a detected vehicle speed of the vehicle, and to select one of the first speech recognition result and the second speech recognition result which is higher in degree of reliability.

### CROSS-REFERENCE TO RELATED APPLICATION

This application claims priority to Japanese Patent Application No. 2018-007064 filed on Jan. 19, 2018, incorporated herein by reference in its entirety.

### BACKGROUND

### 1. Technical Field

The disclosure relates to a speech recognition device and a speech recognition method.

### 2. Description of Related Art

There is known a vehicular speech recognition device that can correctly recognize a speech even when variably changing noise is superimposed on the speech (e.g., see Japanese Patent Application Publication No. 2005-017709 (JP 2005-017709 A)). A speech recognition unit of this device stores a plurality of acoustic models, and selects one of the stored acoustic models based on an input vehicle speed signal and an input air-conditioning air volume signal. Then, the device carries out speech recognition by comparing a speech signal pattern of a speech signal input from a microphone with the features of a signal pattern for each phoneme in the selected acoustic model, and outputs an operation command to a navigation unit.

Besides, there is known an art of removing noise from a speech signal captured by a microphone and acoustically recognizing the noise-free speech signal in an in-vehicle speech recognition device (e.g., see Japanese Patent Application Publication No. 2008-224960 (JP 2008-224960 A)).

### SUMMARY

In the art of Japanese Patent Application Publication No. 2005-017709 (JP 2005-017709 A), the speech recognition process of the speech recognition unit needs to be changed to adjust to each of the plurality of acoustic models. Therefore, the configuration becomes complicated especially in the case where this configuration includes a plurality of speech, recognition units. Besides, in the art of Japanese Patent Application Publication No. 2008-224960 (JP 2008-224960 A), a filter, an amplifier, and a configuration for adjusting the filter and the amplifier are needed to remove noise, so the configuration becomes complicated.

The disclosure provides a technology that can enhance the accuracy of speech recognition in a vehicle interior with a simple configuration.

A first aspect of the disclosure provides a speech recognition device including: a communication unit configured to transmit data on a speech uttered by a passenger of a vehicle to a server device, and receive a first speech recognition result and a degree of reliability of the first speech recognition result from the server device, the server device being configured to acoustically recognize the speech and derive the first speech recognition result and the degree of reliability of the first speech recognition result; a speech recognition unit configured to acoustically recognize the speech and output a second speech recognition result and a degree of reliability of the second speech recognition result; and a selection unit configured to correct at least one of the degree of reliability of the first speech recognition result and the degree of reliability of the second speech recognition result with a correction value corresponding to a detected vehicle speed of the vehicle, based on a corresponding relationship determined in advance between the vehicle speed of the vehicle and the correction value, and to select one of the first speech recognition result and the second speech recognition result which is higher in degree of reliability.

In the first aspect, the number of words that the speech recognition unit is able to acoustically recognize may be smaller than the number of words that the server device is able to acoustically recognize.

In the first aspect, the correction value may increase as the vehicle speed of the vehicle rises, in the corresponding relationship, and the selection unit may be configured to add the correction value corresponding to the detected vehicle speed of the vehicle to the degree of reliability of the second speech recognition result.

According to the above configurations, the degree of reliability of the first speech recognition result or the degree of reliability of the second recognition result is corrected with the correction value corresponding to the detected vehicle speed. Therefore, when the vehicle speed is relatively high, namely, when noise is relatively loud, the possibility of selecting the second speech recognition result by the in-vehicle speech recognition unit can be enhanced. In the case where the number of words that can be acoustically recognized by the speech recognition unit is smaller than the number of words that can be acoustically recognized by the server device and noise is relatively loud, the speech recognition unit is less likely to falsely recognize a speech than the server device as long as the speech consists of words that can be acoustically recognized by the speech recognition unit. Therefore, when noise is relatively loud, the possibility of false recognition can be reduced. Besides, there is no need to change the speech recognition process of the speech recognition unit, and there is no need to provide a configuration for removing noise, either. In consequence, the accuracy of speech recognition in the vehicle interior can be enhanced with a simple configuration.

In the first aspect, the communication unit, the speech recognition unit, and the selection unit may be mounted in the vehicle.

In the first aspect, the selection unit may be configured to compare the degree of reliability of the second speech recognition result and a predetermined threshold with each other, and the selection unit may be configured to select the second speech recognition result as the speech uttered by the passenger of the vehicle, without comparing the degree of reliability of the first speech recognition result and the degree of reliability of the second speech recognition result with each other, when the degree of reliability of the second speech recognition result is equal to or higher than the predetermined threshold.

A second aspect of the disclosure provides a speech recognition method including: transmitting data on a speech uttered by a passenger of a vehicle to a server device, the server device being configured to acoustically recognize the speech and output a first speech recognition result and a degree of reliability of the first speech recognition result; receiving they first speech recognition result and the degree of reliability of the first speech recognition result from the server device; acoustically recognizing the speech and outputting a second speech recognition result and a degree of reliability of the second speech recognition result and correcting the degree of reliability of the first speech recognition result or the degree of reliability of the second speech recognition result with a correction value corresponding to a detected vehicle speed of the vehicle, based on a corresponding relationship determined in advance between the vehicle speed of the vehicle and the correction value, and selecting one of the first speech recognition result and the second speech recognition result which is higher in degree of reliability.

### BRIEF DESCRIPTION OF THE DRAWINGS

Features, advantages, and technical and industrial significance of an exemplary embodiment of the disclosure will be described below with reference to the accompanying drawings, in which like numerals denote like elements, and wherein:

FIG. 1 is a block diagram showing the configuration of a speech recognition system according to the embodiment;

FIG. 2 is a view showing the frequency distribution of the degree of reliability of a second speech recognition result obtained by a speech recognition unit of FIG. 1, with a vehicle stopped;

FIG. 3 is a view showing the frequency distribution of the degree of reliability of the second speech recognition result obtained by the speech recognition unit of FIG. 1, with the vehicle running; and

FIG. 4 is a flowchart showing a process of the speech recognition system of FIG. 1.

### DETAILED DESCRIPTION

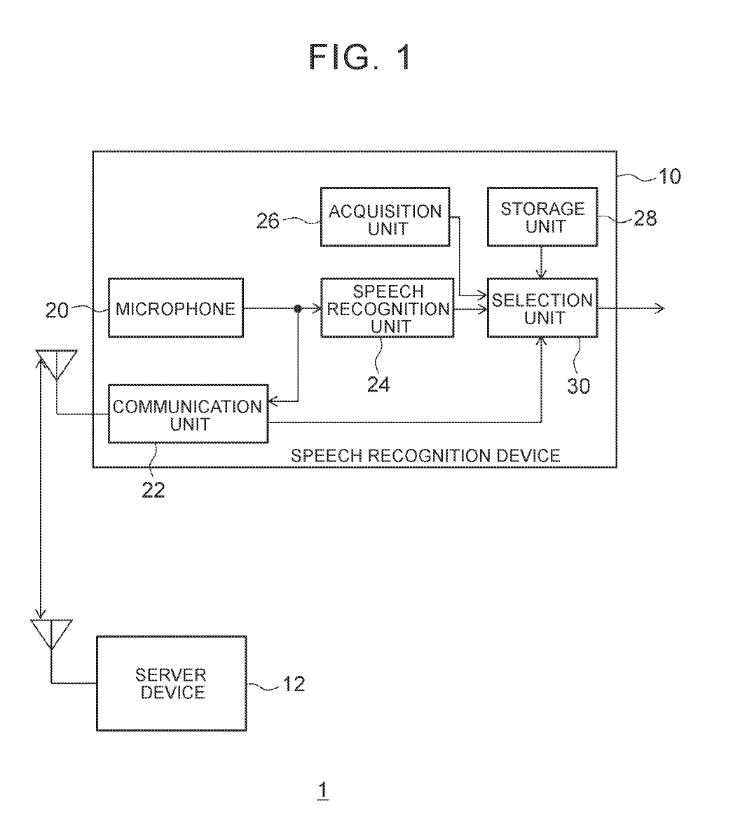

FIG. 1 is a block diagram showing the configuration of a speech recognition system 1 according to the embodiment. The speech recognition system 1 is equipped with a speech recognition device 10 and a server device 12. The speech recognition device 10 is mounted in a vehicle. The speech recognition device 10 is equipped with a microphone 20, a communication unit 22, a speech recognition unit 24, an acquisition unit 26, a storage unit 28, and a selection unit 30.

The microphone 20 acquires a speech uttered by a passenger of the vehicle, and outputs speech data on the speech to the communication unit 22 and the speech recognition unit 24. The microphone 20 also acquires noise such as engine noise of the vehicle, road noise, and the like. The noise acquired by the microphone 20 increases as the vehicle speed of the vehicle rises.

The communication unit 22 is a communication device that can establish wireless communication with the server device 12. The standard of this wireless communication is not limited in particular, but includes, for example, a third-generation mobile communication system (3G), a fourth-generation mobile communication system (4G), or a fifth-generation mobile communication system (5G). The communication unit 22 may establish wireless communication with the server device 12 via a base station (not shown). The communication unit 22 transmits the speech data output from the microphone 20 to the server device 12.

The server device 12 acoustically recognizes the speech uttered by the passenger, based on the speech data transmitted from the communication unit 22, and derives a first speech recognition result and a degree of reliability of the first speech recognition result. The server device 12 stores a plurality of predetermined words that can be acoustically recognized, selects some of the stored words that are closest to a recognized letter string, and outputs the selected words as the first speech recognition result. The degree of reliability indicates the possibility of correct recognition of the words from the speech data. The possibility of correct recognition of the words increases as the degree of reliability rises. The degree of reliability of the first speech recognition result tends to fall as the noise acquired by the microphone 20 increases. The degree of reliability of the first speech recognition result can be derived through the use of a well-known technology. The server device 12 transmits the first speech recognition result and the degree of reliability of the first speech recognition result to the speech recognition device 10. The server device 12 is installed in, for example, a data center or the like.

The communication unit 22 of the speech recognition device 10 receives the first speech recognition result and the degree of reliability of the first speech recognition result from the server device 12. The communication unit 22 outputs the received information to the selection unit 30.

The speech recognition unit 24 acoustically recognizes a speech based on the speech data output from the microphone 20, and outputs a second speech recognition result and a degree of reliability of the second speech recognition result to the selection unit 30. The speech recognition unit 24 stores a plurality or predetermined words that can be acoustically recognized, selects some of the stored words that are closest to a recognized letter string, and outputs the selected words as the second speech recognition result. The predetermined words that can be acoustically recognized by the speech recognition unit 24 can also said to be a predetermined command. The number of words that can be acoustically recognized by the speech recognition unit 24 is smaller than the number of words that can be acoustically recognized by the server device 12. The degree of reliability of the second speech recognition, result tends to fall as the noise acquired by the microphone 20 increases. The degree of reliability of the second speech recognition result can be derived through the use of a well-known technology.

A time from the acquisition of the speech by the microphone 20 to the outputting of the second speech recognition result and the degree of reliability of the second speech recognition result by the speech recognition unit 24 is shorter than a time from the acquisition of the speech by the microphone 20 to the reception of the first speech recognition result and the degree of reliability of the first speech recognition result from the server device 12 by the communication unit 22.

The acquisition unit 26 acquires information on a vehicle speed of the vehicle detected by a vehicle speed sensor (not shown). The acquisition unit 26 outputs the information on the vehicle speed to the selection unit 30.

The storage unit 28 stores a threshold determined in advance, and a corresponding relationship determined in advance between the vehicle speed of the vehicle and a correction value. For example, in the corresponding relationship between the vehicle speed and the correction value, the correction value increases as the vehicle speed of the vehicle rises. The threshold and the corresponding relationship between the vehicle speed and the correction value can be appropriately set through an experiment.

The selection unit 30 compares the degree of reliability of the second speech recognition result and the threshold stored in the storage unit 28 with each other. When the degree of reliability of the second speech recognition result is equal to or higher than the threshold, the selection unit 30 selects the second speech recognition result. That is, when the degree of reliability of the second speech recognition result is equal to or higher than the threshold, the selection unit 30 does not await the first speech recognition result output from the server device 12.

When the degree of reliability of the second speech recognition result is lower than the threshold, the selection unit 30 corrects the degree of reliability of the first speech recognition result or the degree of reliability of the second speech recognition result with the correction value corresponding to the vehicle speed of the vehicle output from the acquisition unit 26, based on the corresponding relationship stored in the storage unit 28. In this case, the selection unit 30 adds the correction value corresponding to the detected vehicle speed of the vehicle to the degree of reliability of the second speech recognition result. That is, the selection unit 30 corrects the degree of reliability of the second speech recognition result. The selection unit 30 selects that one of the first speech recognition result and the second speech recognition result which is higher in degree of reliability.

The selection unit 30 outputs the selected first speech recognition result or the selected second speech recognition result to an in-vehicle device such as a car navigation device (not shown) or the like. For example, the car navigation device performs various functions such as the setting of a destination, the retrieval of a phone number, and the like, based on the first speech recognition result or second speech recognition result output from the selection unit 30.

An exemplary method of setting the threshold will now be described. First of all, a plurality of evaluation audio sources are prepared. The evaluation audio sources include a group of command phrases that are desired to be recognized by the in-vehicle speech recognition unit 24, and a group of natural spoken phrases that are desired to be recognized by the server device 12. For example, a group of about 1000 command phrases and a group of about 1000 natural spoken phrases may be prepared.

Subsequently, the speech recognition unit 24 acoustically recognizes the group of the command phrases and the group of the natural spoken phrases with the vehicle stopped, namely, with the vehicle speed equal to zero, and derives frequency distributions of the degree of reliability of the second speech recognition result in the case here the second speech recognition result is correct and in the case where the second speech recognition result is incorrect, respectively.

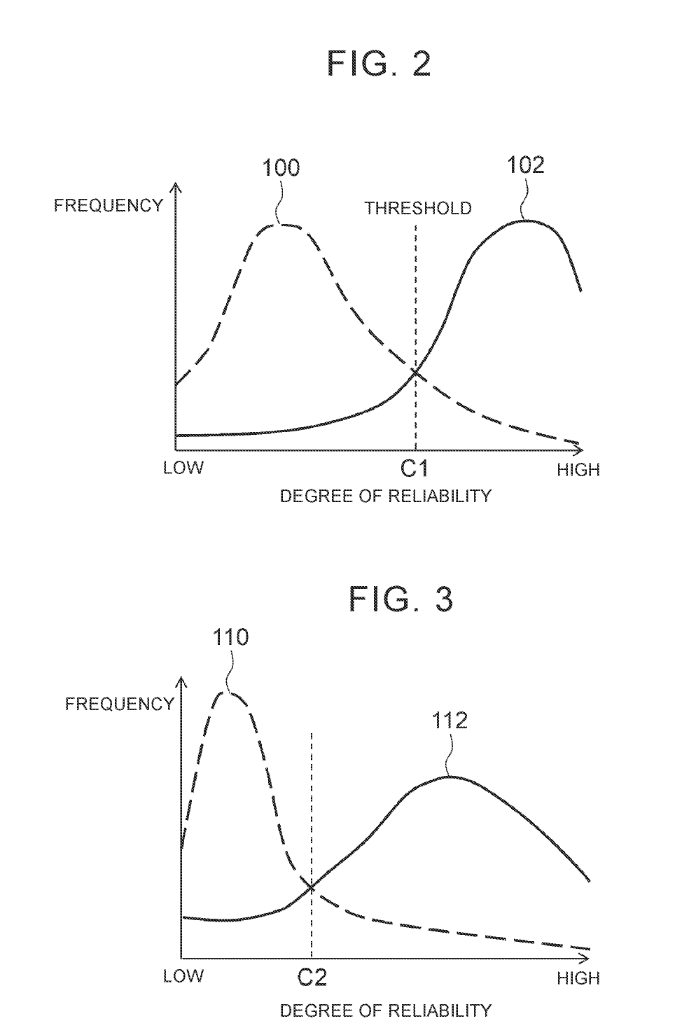

FIG. 2 is a view showing the frequency distribution of the degree of reliability of the second speech recognition result with the vehicle stopped, according to the speech recognition unit 24 of FIG. 1. A frequency distribution 100 of the degree of reliability of the second speech recognition result in the case where the second speech recognition result is correct is mainly obtained from the group of the command phrases. A frequency distribution 102 of the degree of reliability of the second speech recognition result in the case where the second speech recognition result is incorrect is mainly obtained from the group of the natural spoken phrases.

Subsequently, the threshold of the degree of reliability in the case where the vehicle speed is equal to zero is determined from the frequency distribution of FIG. 2. The method of determining the threshold is not limited in particular. However, as shown in, for example, FIG. 2, a degree of reliability C1 with which the sum of the number of unselected correct results and the number of selected incorrect results is minimized is determined as the threshold. This threshold is stored into the storage unit 28.

Next, an exemplary method of setting the corresponding relationship between the vehicle speed and the correction value will be described. In the same manner as described above, the speech recognition unit 24 acoustically recognizes the group of the command phrases and the group of the natural spoken phrases with the vehicle running, for example, with the vehicle, speed equal to 100 km/h, and derives frequency distributions of the degree of reliability of the second speech recognition result in the case where the second speech recognition result is correct and in the case where the second speech recognition result is incorrect, respectively.

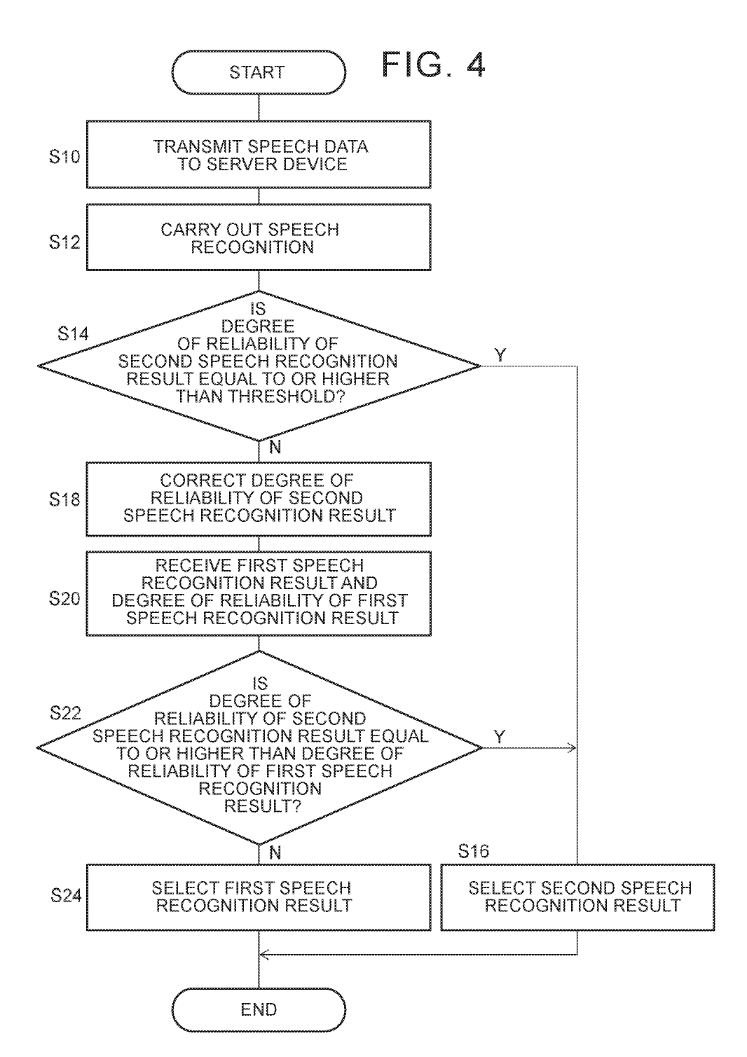

FIG. 3 is a view showing the frequency distribution of the degree of reliability of the second speech recognition result with the vehicle running, according to the speech recognition unit 24 of FIG. 1. The degrees of reliability of a frequency distribution 110 and a frequency distribution 112 are biased toward the lower side than in FIG. 2, due to the influence of noise.

Subsequently, in the same manner as in the case of FIG. 2, a degree of reliability C2 with which the sum of the number of unselected correct results and the number of selected incorrect results is minimized with the vehicle speed equal to 100 km/h is determined. Then, a difference between the degree of reliability C2 determined in FIG. 3 and the threshold of FIG. 2 is derived. This process is performed as to other vehicle speeds as well, and a difference between the degree of reliability with which the sum of the number of unselected correct results and the number of selected incorrect results is minimized, as determined at each of the vehicle speeds, and the threshold of FIG. 2 is derived.

Subsequently, the correction value in the case where the vehicle speed is equal to zero is set through an experiment. Then, the difference derived as to each of the above-mentioned vehicle speeds is added to the correction value in the case where the vehicle speed is equal to zero, and the result of addition is adopted as the correction value at each of the vehicle speeds.

Incidentally, the corresponding relationship between the vehicle speed and the correction value can also be determined according to a variety of arbitrary setting methods. For example, the correction value may be set through an experiment at each of the plurality of the vehicle speeds.

This configuration can be realized hardware-wise by a CPU, a memory, and other LSI's of an arbitrary computer, and is realized software-wise by a program or the like loaded into a memory. For example, the speech recognition unit 24, the acquisition unit 26, the storage unit 28, and the selection unit 30 can be realized by one or a plurality of in-vehicle ECU's. In the present embodiment, functional blocks that are realized through the combination of those units are depicted. Accordingly, those skilled in the art understand that these functional blocks can be realized in various forms only by a piece of hardware, only by a piece of software, or through the combination thereof.

Next, the overall operation of the speech recognition system 1 according to the foregoing configuration will be described. FIG. 4 is a flowchart showing the process of the speech recognition system 1 of FIG. 1. A process of FIG. 4 is performed when the microphone 20 outputs speech data on a speech.

The communication unit 22 transmits speech data to the server device 12 (S10). The speech recognition unit 24 carries out speech recognition based on the speech data (S12). If the degree of reliability of the second speech recognition result is equal to or higher than the threshold (Y in S14), the selection unit 30 selects the second speech recognition result (S16), and ends the process.

If the degree of reliability of the second speech recognition result is lower than the threshold (N in S14), the selection unit 30 corrects the degree of reliability of the second speech recognition result with the correction value corresponding to the vehicle speed (S18). The communication unit 22 receives the first speech recognition result and the degree of reliability of the first speech recognition result from the server device 12 (S20). The processing of step S20 may be carried out between step S12 and step S14, or may be carried out between step S14 and step S18.

If the degree of reliability of the second speech recognition result is equal to or higher than the degree of reliability of the first speech recognition result (Y in S22), a transition to step S16 is made. If the degree of reliability of the second speech recognition result is lower than the degree of reliability of the first speech recognition result (N in S22), the selection unit 30 selects the first speech recognition result (S24), and ends the process.

Next, concrete examples of the operation of the speech recognition system 1 will be described.

### FIRST EXAMPLE

An example in which the uttered speech is “Yamada calling on the phone” which consists of words that can be acoustically recognized by the speech recognition unit 24, will be described. Besides, it is assumed that the vehicle speed is relatively high, for example, 100 km/h, that the degree of reliability of the first speech recognition result is 7000, and that the degree of reliability of the second speech recognition result is 5500 and lower than the threshold.

Since the degree of reliability of the second speech recognition result is lower than the threshold, the selection unit 30 corrects the degree of reliability of the second speech recognition result. When the correction value at this vehicle speed is, for example, 2000, the corrected degree of reliability of the second speech recognition result is 7500 and hence higher than the degree of reliability of the first speech recognition result. Therefore, the selection unit 30 selects the second speech recognition result. In other words, the selection unit 30 recognizes the second speech recognition result as the speech uttered by the passenger.

When the vehicle speed is relatively high, namely, when noise is relatively loud, the speech recognition unit 24 is less likely to falsely recognize a speech than the server device 12 as long as the speech consists of words that can be acoustically recognized by the speech recognition unit 24. This is because the number of words that can be acoustically recognized by the speech recognition unit 24 is smaller than the number of words that can be acoustically recognized by the server device 12, and hence a certain speech is unlikely to be falsely recognized as other words similar to correct words due to the influence of noise. Therefore, when the degree of reliability of the second speech recognition result is relatively high as in this example, the accuracy of speech recognition can be enhanced by selecting the second speech recognition result.

Incidentally, in this first example, when the vehicle speed is lower, the degree of reliability of the second speech recognition result is higher and may become equal to or higher than the threshold. In this case, the selection unit 30 selects the second speech recognition result independently of the degree of reliability of the first speech recognition result.

### SECOND EXAMPLE

An example in which the uttered speech is “is there any good soba noodle shop?”, which includes words that cannot be acoustically recognized by the speech recognition unit 24, will be described. Besides, it is assumed that the vehicle speed is the same as in the first example, that the degree of reliability of the first speech recognition result is 7000, and that the degree of reliability of the second speech recognition result is 2000 and lower than the threshold. The speech recognition unit 24 cannot correctly recognize this speech, so the degree of reliability of the second speech recognition result is lower than in the first example.

In the case where the correction value at this vehicle speed is 2000, the corrected degree of reliability of the second speech recognition result is 4000, which is lower than the degree of reliability of the first speech recognition result. Therefore, the selection unit 30 selects the first speech recognition result.

When the words cannot be acoustically recognized by the speech recognition unit 24, the speech recognition unit 24 falsely recognizes them independently of the level of noise. Therefore, when the degree of reliability of the second speech recognition result is relatively low as in this example, the accuracy of speech recognition, can be enhanced by selecting the first speech recognition result.

As described hitherto, according to the present embodiment, the degree of reliability of the second speech recognition result is corrected with the correction value corresponding to the detected vehicle speed. Therefore, when the vehicle speed is relatively high, namely, when noise is relatively loud, the possibility of selecting the second speech recognition result by the in-vehicle speech recognition unit 24 can be enhanced. In the case where the number of words that can be acoustically recognized by the speech recognition unit 24 is smaller than the number of words that can be acoustically recognized by the server device 12 and noise is relatively loud, the speech recognition unit 24 is less likely to falsely recognize a speech than the server device 12 as long as the speech consists of words that can be acoustically recognized by the speech recognition unit 24. Therefore, when noise is relatively loud, the possibility of false recognition can be reduced.

Besides, there is no need to change the speech recognition process of the speech recognition unit 24, and there is no need to provide a configuration for removing noise, either. In consequence, the accuracy of speech recognition in a vehicle interior can be enhanced with a simple configuration.

In contrast, in a comparative example in which the degree of reliability the second speech recognition result is not corrected, when the vehicle speed is relatively high, the possibility of selecting the acoustically correctly recognized second speech recognition result is low.

The disclosure has been described above based on the embodiment. The embodiment is nothing more than an exemplification, and those skilled in the art understand that various modification examples are possible in combining the respective components and the respective processes, and that such modification examples also fall within the scope of the disclosure.

For example, the threshold of the degree of reliability may change in accordance with the vehicle speed of the vehicle. In this case, the storage unit 28 stores a corresponding relationship between the vehicle speed of the vehicle and the threshold of the degree of reliability. This corresponding relationship can be set by adopting the degree of reliability with which the sum of the number of unselected correct results and the number of selected incorrect results is minimized at each of the vehicle speeds described with reference to FIG. 3, as the threshold at each of the vehicle speeds. The threshold decreases as the vehicle speed rises. The selection unit 30 may specify the threshold corresponding to the vehicle speed of the vehicle output from the acquisition unit 26, based on the corresponding relationship between the vehicle speed stored in the storage unit 28 and the threshold, and compare the specified threshold and the degree of reliability of the second speech recognition result with each other. In this example, when the vehicle speed is relatively high, the possibility of selecting the second speech recognition result of the in-vehicle speech recognition unit 24 can be enhanced without awaiting the first speech recognition result obtained by the server device 12. Incidentally, when the threshold of the degree of reliability changes in accordance with the vehicle speed of the vehicle, the selection unit 30 may not correct the degree of reliability of the first speech recognition result or the degree of reliability of the second speech recognition result with the correction value.

Besides, the speech recognition system 1 may be equipped with a plurality of server devices having speech recognition performances that are different from one another. When the degree of reliability of the second speech recognition result of the speech recognition unit 24 is lower than the threshold, the selection unit 30 corrects a plurality of degrees of reliability of the first speech recognition results of the plurality of the server devices or the reliability of the second speech recognition result with the correction value corresponding to the vehicle speed, and selects a speech recognition result among the plurality of the first speech recognition results and the second speech recognition result which is higher in degree of reliability. In this modification example, the speech recognition performance of the speech recognition system 1 can be adjusted in more detail.

Besides, the selection unit 30 may correct the degree of reliability of the first speech recognition result by subtracting the correction value corresponding to the detected vehicle speed of the vehicle from the degree of reliability of the first speech recognition result. In this modification example, the degree of freedom in configuring the speech recognition system 1 can be enhanced.

What is claimed is:

1. A speech recognition device comprising;
a communication unit configured to transmit data on a speech uttered by a passenger of a vehicle to a server device, and receive a first speech recognition result and a degree of reliability of the first speech recognition result from the server device, the server device being configured to acoustically recognize the speech and derive the first speech recognition result and the degree of reliability of the first speech recognition result;
a speech recognition unit configured to acoustically recognize the speech and output a second speech recognition result and a degree of reliability of the second speech recognition result; and
a selection unit configured to correct at least one of the degree of reliability of the first speech recognition result and the degree of reliability of the second speech recognition result with a correction value corresponding to a detected vehicle speed of the vehicle, based on a corresponding relationship determined in advance between the vehicle speed of the vehicle and the correction value, and to select one Of the first speech recognition result and the second speech recognition result which is higher in degree of reliability.

2. The speech recognition device according to claim 1, wherein
the number of words that the speech recognition unit is able to acoustically recognize is smaller than the number of words that the server device is able to acoustically recognize.

3. The speech recognition device according to claim 1, wherein
the correction value increases as the vehicle speed of the vehicle rises, in the corresponding relationship, and
the selection unit is configured to add the correction value corresponding to the detected vehicle speed of the vehicle to the degree of reliability of the second speech recognition result.

4. The speech recognition device according to claim 1, wherein
the communication unit, the speech recognition unit, and the selection unit are mounted in the vehicle.

5. The speech recognition device according to claim 1, wherein
the selection unit is configured to compare the degree of reliability of the second speech recognition result and a predetermined threshold with each other, and
the selection unit is configured to select the second speech recognition result as the speech uttered by the passenger of the vehicle, without comparing the degree of reliability of the first speech recognition result and the degree of reliability of the second speech recognition result with each other, when the degree of reliability of the second speech recognition result is equal to or higher than the predetermined threshold.

6. A speech recognition method comprising:
transmitting data on a speech uttered by a passenger of a vehicle to a server device, the server device being configured to acoustically recognize the speech and output a first speech recognition result and a degree of reliability of the first speech recognition result;
receiving the first speech recognition result and the degree of reliability of the first speech recognition result from the server device;
acoustically recognizing the speech and outputting a second speech recognition result and a degree of reliability of the second speech recognition result; and
correcting the degree of reliability of the first speech recognition result or the degree of reliability of the second speech recognition result with a correction value corresponding to a detected vehicle speed of the vehicle, based on a corresponding relationship determined in advance between the vehicle speed of the vehicle and the correction value, and selecting one of the first speech recognition result and the second speech recognition result which is higher in degree of reliability.
